(19) United States
(12) Patent Application Publication
(10) Pub. No.: US 2023/0038434 A1
(43) Pub. Date: Feb. 9, 2023

(54) SYSTEMS AND METHODS FOR REINFORCEMENT LEARNING WITH SUPPLEMENTED STATE DATA

(71) Applicant: ROYAL BANK OF CANADA, Toronto (CA)

(72) Inventors: Hasham BURHANI, Oshawa (CA); Xiao Qi SHI, Richmond Hill (CA)

(21) Appl. No.: 17/397,460

(22) Filed: Aug. 9, 2021

(51) Int. Cl. G06Q 30/02; G06N 3/08; G06N 3/04; G06F 17/18

(52) U.S. Cl. CPC G06Q 30/0201; G06F 17/18; G06N 3/08; G06N 3/0472

(57) ABSTRACT

Systems are methods are provided for training an automated agent. The automated agent maintains a reinforcement learning neural network and generates, according to outputs of the reinforcement learning neural network, signals for communicating resource task requests. The system includes a communication interface, a processor, memory, and software code stored in the memory. The software code, when executed, causes the system to: instantiate an automated agent for communicating resource task requests; receive a current feature data structure related to a resource of the resource task requests; maintain a plurality of historical feature data structures related to said resource for a plurality of prior time steps; compute normalized feature data using the current feature data structure and the plurality of historical feature data structures; compute supplemented state data appended with the normalized feature data; and transmit said supplemented state data to the reinforcement learning neural network to train said automated agent.

### FIELD

The present disclosure generally relates to the field of computer processing and reinforcement learning.

### BACKGROUND

Input data for training a reinforcement learning neural network can include state data, or also known as feature data. The feature data may be extracted and normalized for provision into the neural network. The features typically are generated based on retrieved or generated task data within the environment at a given point in time.

### SUMMARY

In accordance with an aspect, there is provided a computer-implemented system for training an automated agent. The system includes a communication interface, at least one processor, memory in communication with the at least one processor, and software code stored in the memory. The software code, when executed at the at least one processor causes the system to: instantiate an automated agent that maintains a reinforcement learning neural network and generates, according to outputs of said reinforcement learning neural network, signals for communicating resource task requests; receive, by way of said communication interface, a current feature data structure related to a resource of the resource task requests, for a current time step; maintain, in a memory, a plurality of historical feature data structures related to said resource for a plurality of prior time steps; compute normalized feature data using the current feature data structure and the plurality of historical feature data structures; compute supplemented state data appended with the normalized feature data; and transmit said supplemented state data to the reinforcement learning neural network to train said automated agent.

In some embodiments, computing the normalized feature data based on the current feature data structure and the plurality of historical feature data structures may include: computing an average historical feature data structure based on the plurality of historical feature data structures; computing a standard deviation data structure based on the plurality of historical feature data structures; and computing the normalized feature data based on the current feature data structure, the average historical feature data structure and the standard deviation data structure.

In some embodiments, the standard deviation data structure may be computed based on the average historical feature data structure.

In some embodiments, the average historical feature data structure µₜ may be computed based on:

$${μ}_{\text{t}} = \frac{{\sum }_{i \text{=1}}^{\text{N}} {x}_{i}}{\text{N}} \text{,}$$

where xᵢ, i = ₁,₂ ... N represents the plurality of historical feature data structures.

In some embodiments, the standard deviation data structure σₜ may be computed based on:

$${σ}_{t} \text{=} \sqrt{\frac{{\sum }_{i \text{=1}}^{\text{N}} {\left({x}_{i} \text{-} {μ}_{t}\right)}^{\text{2}}}{\text{N}}}$$

In some embodiments, the normalized feature data Zₜ may be computed based on:

$${\text{Z}}_{t} = \frac{{x}_{t} - {μ}_{t}}{{σ}_{t} ,}$$

where xₜ represents the current feature data structure.

In some embodiments, the resource is a security, and the normalized feature data and the plurality of historical feature data structures comprise data representing a feature from: a volatility, a price, a volume, and a market spread.

In some embodiments, the plurality of historical feature data structures is associated with a plurality of consecutive timestamps corresponding to the plurality of prior time steps, each of the plurality of historical feature data structures being respectively associated with each of the plurality of consecutive timestamps.

In some embodiments, the plurality of prior time steps is taken from a period of time immediately preceding the communication of the most recent resource task request by said automated agent.

In some embodiments, the period of time may be predefined or dynamically configured. For example, the period of time may be one minute, one hour, five hours, and so on.

In accordance with another aspect, there is provided a computer-implemented method of training an automated agent. The method includes: instantiating an automated agent that maintains a reinforcement learning neural network and generates, according to outputs of said reinforcement learning neural network, signals for communicating resource task requests; receiving or retrieving, a current feature data structure related to a resource of the resource task requests, for a current time step; maintaining, in a memory, a plurality of historical feature data structures related to said resource for a plurality of prior time steps; computing normalized feature data using the current feature data structure and the plurality of historical feature data structures; computing supplemented state data appended with the normalized feature data; and transmitting said supplemented state data to the reinforcement learning neural network to train said automated agent.

In some embodiments, computing the normalized feature data based on the current feature data structure and the plurality of historical feature data structures may include: computing an average historical feature data structure based on the plurality of historical feature data structures; computing a standard deviation data structure based on the plurality of historical feature data structures; and computing the normalized feature data based on the current feature data structure, the average historical feature data structure and the standard deviation data structure.

In some embodiments, the standard deviation data structure may be computed based on the average historical feature data structure.

In some embodiments, the average historical feature data structure µₜ may be computed based on:

$${μ}_{\text{t}} = \frac{{\sum }_{i = 1}^{\text{N}} {x}_{i}}{\text{N}} ,$$

where xᵢ, i = 1, 2 ... N represents the plurality of historical feature data structures.

In some embodiments, the standard deviation data structure σₜ may be computed based on:

$${σ}_{t} = \sqrt{\frac{{\sum }_{i = 1}^{\text{N}} {\left({x}_{i} - {μ}_{t}\right)}^{2}}{\text{N}}} .$$

In some embodiments, the normalized feature data Zₜ may be computed based on:

$${Z}_{t} = \frac{{x}_{t} - {\text{μ}}_{t}}{{σ}_{t}} ,$$

where xₜ represents the current feature data structure.

In some embodiments, the resource is a security, and the normalized feature data and the plurality of historical feature data structures comprise data representing a feature from: a volatility, a price, a volume, and a market spread.

In some embodiments, the plurality of historical feature data structures is associated with a plurality of consecutive timestamps corresponding to the plurality of prior time steps, each of the plurality of historical feature data structures being respectively associated with each of the plurality of consecutive timestamps.

In some embodiments, the plurality of prior time steps is taken from a period of time immediately preceding the communication of the most recent resource task request by said automated agent.

In some embodiments, the period of time may be predefined or dynamically configured. For example, the period of time may be one minute, one hour, five hours, and so on.

In accordance with yet another aspect, there is provided a non-transitory computer-readable storage medium storing instructions which when executed adapt at least one computing device to: instantiate an automated agent that maintains a reinforcement learning neural network and generates, according to outputs of said reinforcement learning neural network, signals for communicating resource task requests; receive or retrieve, a current feature data structure related to a resource of the resource task requests, for a current time step; maintain, in a memory, a plurality of historical feature data structures related to said resource for a plurality of prior time steps; compute normalized feature data using the current feature data structure and the plurality of historical feature data structures; compute supplemented state data appended with the normalized feature data; and transmit said supplemented state data to the reinforcement learning neural network to train said automated agent.

In some embodiments, computing the normalized feature data based on the current feature data structure and the plurality of historical feature data structures may include: computing an average historical feature data structure based on the plurality of historical feature data structures; computing a standard deviation data structure based on the plurality of historical feature data structures; and computing the normalized feature data based on the current feature data structure, the average historical feature data structure and the standard deviation data structure.

In some embodiments, the standard deviation data structure may be computed based on the average historical feature data structure.

In some embodiments, the average historical feature data structure µₜ may be computed based on:

$${\text{μ}}_{t} = \frac{{\sum }_{i = 1}^{\text{N}} {x}_{i}}{\text{N}} , \text{where} {x}_{i ,} i = 1 , 2 … N$$

represents the plurality of historical feature data structures.

In some embodiments, the standard deviation data structure σₜ may be computed based on:

$${σ}_{t} = \sqrt{\frac{{\sum }_{i = 1}^{\text{N}} {( {x}_{i} - {\text{μ}}_{t} )}^{2}}{\text{N}}}$$

In some embodiments, the normalized feature data Zₜ may be computed based on:

$${Z}_{t} = \frac{{x}_{t} - {\text{μ}}_{t}}{{σ}_{t}} ,$$

where xₜ represents the current feature data structure.

In some embodiments, the resource is a security, and the normalized feature data and the plurality of historical feature data structures comprise data representing a feature from: a volatility, a price, a volume, and a market spread.

In some embodiments, the plurality of historical feature data structures is associated with a plurality of consecutive timestamps corresponding to the plurality of prior time steps, each of the plurality of historical feature data structures being respectively associated with each of the plurality of consecutive timestamps.

In some embodiments, the plurality of prior time steps is taken from a period of time immediately preceding the communication of the most recent resource task request by said automated agent.

In some embodiments, the period of time may be predefined or dynamically configured. For example, the period of time may be one minute, one hour, five hours, and so on.

In accordance with another aspect, there is provided a trade execution platform integrating a reinforcement learning process based on the methods as described above.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the Figures, which illustrate example embodiments,

FIG. 1A is a schematic diagram of a computer-implemented system for training an automated agent, exemplary of embodiments.

FIG. 1B is a schematic diagram of an automated agent, exemplary of embodiments.

FIG. 2 is a schematic diagram of an example neural network maintained at the computer-implemented system of FIG. 1A.

FIG. 3 is a schematic diagram showing an example process with self-awareness inputs for training the neural network of FIG. 2.

FIG. 4 is a schematic diagram of a system having a plurality of automated agents, exemplary of embodiments.

FIG. 5 is a flowchart of an example method of training an automated agent, exemplary of embodiments.

### DETAILED DESCRIPTION

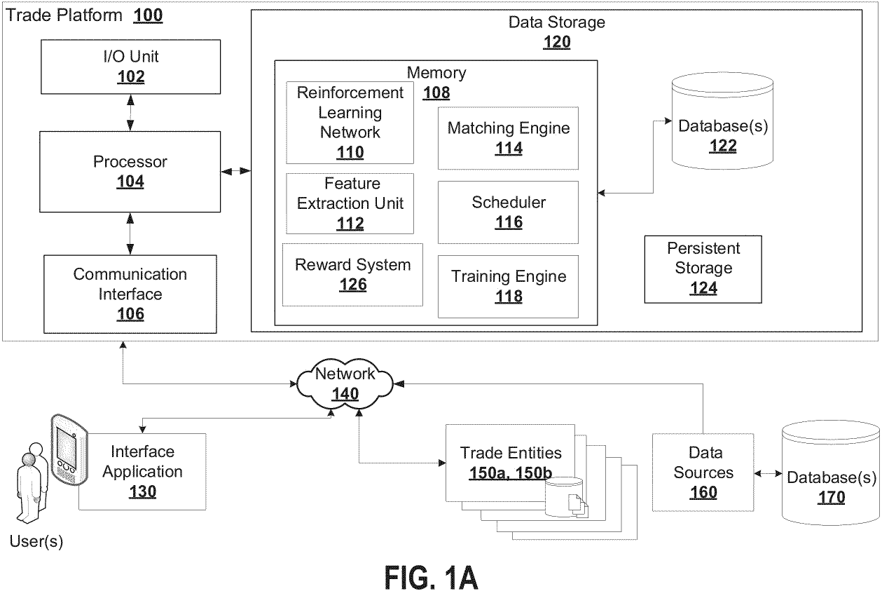

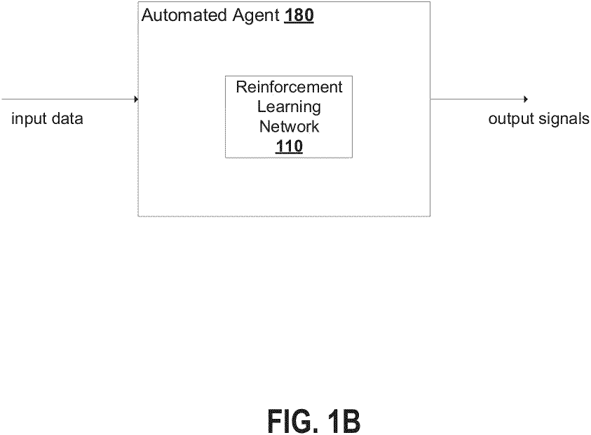

FIG. 1A is a high-level schematic diagram of a computer-implemented system 100 for training an automated agent having a neural network, exemplary of embodiments. The automated agent is instantiated and trained by system 100 in manners disclosed herein to generate task requests.

As detailed herein, in some embodiments, system 100 includes features adapting it to perform certain specialized purposes, e.g., to function as a trading platform. In such embodiments, system 100 may be referred to as trading platform 100 or simply as platform 100 for convenience. In such embodiments, the automated agent may generate requests for tasks to be performed in relation to securities (e.g., stocks, bonds, options or other negotiable financial instruments). For example, the automated agent may generate requests to trade (e.g., buy and/or sell) securities by way of a trading venue.

Referring now to the embodiment depicted in FIG. 1A, trading platform 100 has data storage 120 storing a model for a reinforcement learning neural network. The model is used by trading platform 100 to instantiate one or more automated agents 180 (FIG. 1B) that each maintain a reinforcement learning neural network 110 (which may be referred to as a reinforcement learning network 110 or network 110 for convenience).

A processor 104 is configured to execute machine-executable instructions to train a reinforcement learning network 110 based on a reward system 126. The reward system generates good (or positive) signals and bad (or negative) signals to train automated agents 180 to perform desired tasks more optimally, e.g., to minimize and maximize certain performance metrics. In some embodiments, an automated agent 180 may be trained by way of signals generated in accordance with reward system 126 to minimize Volume Weighted Average Price (VWAP) slippage. For example, reward system 126 may implement rewards and punishments substantially as described in U.S. Pat. Application No. 16/426196, entitled “Trade platform with reinforcement learning”, filed May 30, 2019, the entire contents of which are hereby incorporated by reference herein.

In some embodiments, trading platform 100 can generate reward data by normalizing the differences of the plurality of data values (e.g. VWAP slippage), using a mean and a standard deviation of the distribution.

In some embodiments, trading platform 100 can normalize input data for training the reinforcement learning network 110. The input normalization process can involve a feature extraction unit 112 processing input data to generate different features such as pricing features, volume features, time features, Volume Weighted Average Price features, market spread features. The pricing features can be price comparison features, passive price features, gap features, and aggressive price features. The market spread features can be spread averages computed over different time frames. The Volume Weighted Average Price features can be current Volume Weighted Average Price features and quoted Volume Weighted Average Price features. The volume features can be a total volume of an order, a ratio of volume remaining for order execution, and schedule satisfaction. The time features can be current time of market, a ratio of time remaining for order execution, and a ratio of order duration and trading period length.

The input normalization process can involve computing upper bounds, lower bounds, and a bounds satisfaction ratio; and training the reinforcement learning network using the upper bounds, the lower bounds, and the bounds satisfaction ratio. The input normalization process can involve computing a normalized order count, a normalized market quote and/or a normalized market trade. The platform 100 can have a scheduler 116 configured to follow a historical Volume Weighted Average Price curve to control the reinforcement learning network 110 within schedule satisfaction bounds computed using order volume and order duration.

The platform 100 can connect to an interface application 130 installed on user device to receive input data. Trade entities 150a, 150b can interact with the platform to receive output data and provide input data. The trade entities 150a, 150b can have at least one computing device. The platform 100 can train one or more reinforcement learning neural networks 110. The trained reinforcement learning networks 110 can be used by platform 100 or can be for transmission to trade entities 150a, 150b, in some embodiments. The platform 100 can process trade orders using the reinforcement learning network 110 in response to commands from trade entities 150a, 150b, in some embodiments.

The platform 100 can connect to different data sources 160 and databases 170 to receive input data and receive output data for storage. The input data can represent trade orders. Network 140 (or multiple networks) is capable of carrying data and can involve wired connections, wireless connections, or a combination thereof. Network 140 may involve different network communication technologies, standards and protocols, for example.

The platform 100 can include an I/O unit 102, a processor 104, communication interface 106, and data storage 120. The I/O unit 102 can enable the platform 100 to interconnect with one or more input devices, such as a keyboard, mouse, camera, touch screen and a microphone, and/or with one or more output devices such as a display screen and a speaker.

The processor 104 can execute instructions in memory 108 to implement aspects of processes described herein. The processor 104 can execute instructions in memory 108 to configure a data collection unit, interface unit (to provide control commands to interface application 130), reinforcement learning network 110, feature extraction unit 112, matching engine 114, scheduler 116, training engine 118, reward system 126, and other functions described herein. The processor 104 can be, for example, any type of general-purpose microprocessor or microcontroller, a digital signal processing (DSP) processor, an integrated circuit, a field programmable gate array (FPGA), a reconfigurable processor, or any combination thereof.

As depicted in FIG. 1B, automated agent 180 receives input data (via a data collection unit) and generates output signal according to its reinforcement learning network 110 for provision to trade entities 150a, 150b. Reinforcement learning network 110 can refer to a neural network that implements reinforcement learning.

Throughout this disclosure, feature data, state data, and other types of data may also be referred to as feature data structure(s), state data structure(s), and other types of data structure(s). A data structure may include a collection of data values, or a singular data value. A data structure may be, for example, a data array, a vector, a table, a matrix, and so on.

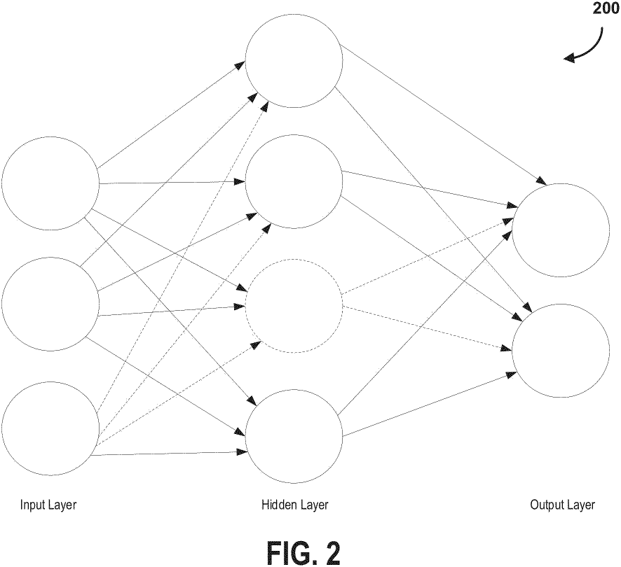

FIG. 2 is a schematic diagram of an example neural network 200 according to some embodiments. The example neural network 200 can include an input layer, a hidden layer, and an output layer. The neural network 200 processes input data using its layers based on reinforcement learning, for example.

Reinforcement learning is a category of machine learning that configures agents, such the automated agents 180 described herein, to take actions in an environment to maximize a notion of a reward. The processor 104 is configured with machine executable instructions to instantiate an automated agent 180 that maintains a reinforcement learning neural network 110 (also referred to as a reinforcement learning network 110 for convenience), and to train the reinforcement learning network 110 of the automated agent 180 using a training unit 118. The processor 104 is configured to use the reward system 126 in relation to the reinforcement learning network 110 actions to generate good signals and bad signals for feedback to the reinforcement learning network 110. In some embodiments, the reward system 126 generates good signals and bad signals to minimize Volume Weighted Average Price slippage, for example. Reward system 126 is configured to receive control the reinforcement learning network 110 to process input data in order to generate output signals. Input data may include trade orders, various feedback data (e.g., rewards), or feature selection data, or data reflective of completed tasks (e.g., executed trades), data reflective of trading schedules, etc. Output signals may include signals for communicating resource task requests, e.g., a request to trade in a certain security. For convenience, a good signal may be referred to as a “positive reward” or simply as a reward, and a bad signal may be referred as a “negative reward” or as a punishment.

Referring again to FIG. 1, feature extraction unit 112 is configured to process input data to compute a variety of features. The input data can represent a trade order. Example features include pricing features, volume features, time features, Volume Weighted Average Price features, market spread features. These features may be processed to compute a state data, which can be a state vector. The state data may be used as input to train the automated agent(s)108.

Matching engine 114 is configured to implement a training exchange defined by liquidity, counter parties, market makers and exchange rules. The matching engine 114 can be a highly performant stock market simulation environment designed to provide rich datasets and ever changing experiences to reinforcement learning networks 110 (e.g. of agents 180) in order to accelerate and improve their learning. The processor 104 may be configured to provide a liquidity filter to process the received input data for provision to the machine engine 114, for example. In some embodiments, matching engine 114 may be implemented in manners substantially as described in U.S. Patent Application No. 16/423082, entitled “Trade platform with reinforcement learning network and matching engine”, filed May 27, 2019, the entire contents of which are hereby incorporated herein.

Scheduler 116 is configured to follow a historical Volume Weighted Average Price curve to control the reinforcement learning network 110 within schedule satisfaction bounds computed using order volume and order duration.

The interface unit 130 interacts with the trading platform 100 to exchange data (including control commands) and generates visual elements for display at user device. The visual elements can represent reinforcement learning networks 110 and output generated by reinforcement learning networks 110.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 may serve multiple users which may operate trade entities 150a, 150b.

The data storage 120 may be configured to store information associated with or created by the components in memory 108 and may also include machine executable instructions. The data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

A reward system 126 integrates with the reinforcement learning network 110, dictating what constitutes good and bad results within the environment. In some embodiments, the reward system 126 is primarily based around a common metric in trade execution called the Volume Weighted Average Price (“VWAP”). The reward system 126 can implement a process in which VWAP is normalized and converted into the reward that is fed into models of reinforcement learning networks 110. The reinforcement learning network 110 processes one large order at a time, denoted a parent order (i.e. Buy 10000 shares of RY.TO), and places orders on the live market in small child slices (i.e. Buy 100 shares of RY.TO @ 110.00). A reward can be calculated on the parent order level (i.e. no metrics are shared across multiple parent orders that the reinforcement learning network 110 may be processing concurrently) in some embodiments.

To achieve proper learning, the reinforcement learning network 110 is configured with the ability to automatically learn based on good and bad signals. To teach the reinforcement learning network 110 how to minimize VWAP slippage, the reward system 126 provides good and bad signals to minimize VWAP slippage.

The reward system 126 can normalize the reward for provision to the reinforcement learning network 110. The processor 104 is configured to use the reward system 126 to process input data to generate Volume Weighted Average Price data. The input data can represent a parent trade order. The reward system 126 can compute reward data using the Volume Weighted Average Price and compute output data by processing the reward data using the reinforcement learning network 110. In some embodiments, reward normalization may involve transmitting trade instructions for a plurality of child trade order slices based on the generated output data.

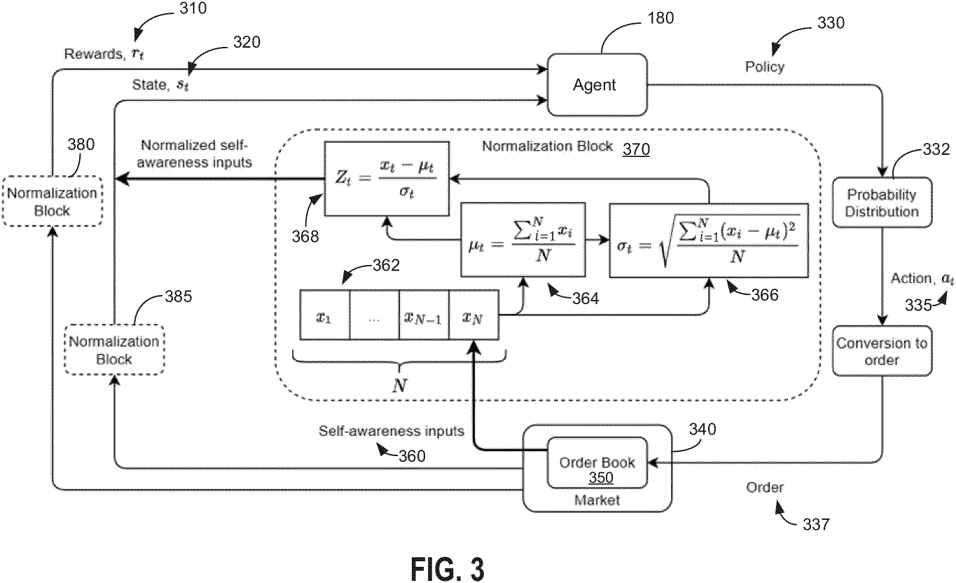

FIG. 3 illustrates a schematic diagram showing an example process with self-awareness inputs for training the neural network of FIG. 2. At each time step (t₁, t₂, ... tₙ), platform 100 receives task data, e.g., directly from a trading venue or indirectly by way of an intermediary. Task data can include data relating to tasks completed in a given time interval (e.g., t₁ to t₂, t₂ to t₃, ..., tₙ₋₁ to tₙ) in connection with a given resource. For example, tasks may include trades of a given security in the time interval. In this circumstance, task data includes values of the given security such as prices and volumes of trades. In some embodiment, task data includes values for prices and volumes for tasks completed in response to previous requests (e.g., previous resource task requests) communicated by an automated agent 180 and for tasks completed in response to requests by other entities (e.g., the rest of the market). Such other entities may include, for example, other automated agents 180 or human traders.

At each time step, the task data may be processed by a feature extraction unit 112 (see e.g., FIG. 1) of platform 100 to compute a feature data, or also known as a feature data structure, including a variety of features for the given resource (e.g., security). The feature data (or feature data structure) can represent a trade order. An example feature from the feature data structure can include pricing features, volume features, time features, Volume Weighted Average Price features, market spread features. These features may be processed to compute a state data Sₜ 320, which can be a state vector, or a state data structure. The state data 320 may be used as input to train the automated agent(s)108.

At each time step, a reward system 126 can process the task data to calculate performance metrics, which may be a reward rt 310, that measure the performance of an automated agent 180, e.g., in the prior time interval. In some embodiments, performance metrics rt 310 can measure the performance of an automated agent 180 relative to the market 340 (i.e., including the aforementioned other entities).

In some embodiments, each time interval (i.e., time between each of t₁ to t₂, t₂ to t₃, ..., tₙ₋₁ to tₙ) is substantially less than one day. In one particular embodiment, each time interval has a duration between 0-6 hours. In one particular embodiment, each time interval has a duration less than 1 hour. In one particular embodiment, a median duration of the time intervals is less than 1 hour. In one particular embodiment, a median duration of the time intervals is less than 1 minute. In one particular embodiment, a median duration of the time interval is less than 1 second.

As will be appreciated, having a time interval substantially less than one day provides opportunity for automated agents 180 to learn and change how task requests are generated over the course of a day. In some embodiments, the duration of the time interval may be adjusted in dependence on the volume of trade activity for a given trade venue. In some embodiments, duration of the time interval may be adjusted in dependence on the volume of trade activity for a given resource.

In the interest of improving the stability, and efficacy of the reinforcement learning network 110 model training, then platform 100 can normalize the task data, the reward 310, and/ or the state data 320, of the reinforcement learning network 110 model in a number of ways. The platform 100 can implement different processes to normalize the state space. Normalization can transform input data into a range or format that is understandable by the model or reinforcement learning network 110. For example, platform 100 may normalize part or all of the task data in a normalization process or block 380 during the process of generating the reward 310. For another example, platform 100 may normalize part or all of the task data in a normalization process or block 385 during the process of generating the state data 320.

Neural networks have very a range of values that inputs have to be in for the neural network to be effective. Input normalization can refer to scaling or transforming input values for provision to neural networks. For example, in some machine learning processes the max/min values can be predefined (pixel values in images) or a computed mean and standard deviation can be used, then the input values to mean 0 and standard deviation of 1 can be converted. In trading, this approach might not work. The mean or the standard deviation of the inputs, can be computed from historical values. However, this may not be the best way to normalize, as the mean or standard deviation can change as the market changes. The platform 100 can address this challenge in a number of different ways for the input space.

The training engine 118 can normalize the task data for training the reinforcement learning network 110. The processor 104 is configured for processing the task data to compute different features. Example features include pricing features, volume features, time features, Volume Weighted Average Price features, market spread features, and so on. The input data represents a trade order for processing by reinforcement learning network 110. The processor 104 is configured to train reinforcement learning network 110 with the training engine 118 using the pricing features, volume features, time features, Volume Weighted Average Price features and market spread features.

In some embodiments, as shown in FIG. 3, self-awareness input data 360 from an order book 350 may be used to further refine, or expand, the state data Sₜ 320 at time t. Unlike conventional measures of market data from the market 340 or an intermediary, the self-awareness input data 360 are generated directly from local experiences of the agent 180, in real time or near real time. An automated agent 180, with a given set of reward rₜ 310 and state data Sₜ 320, may take an action αₜ 335 based on an existing policy 330. For example, the policy 330 can be a probability distribution function 332, which determines that an action αₜ 335 is to be taken at time t under the state defined by the state data Sₜ 320, in order to maximize the reward rₜ 310.

The action αₜ 335 may be a resource task request, at time t, for a specific resource (e.g., a security), which can be, for example, “purchase a security X at price Y”. The resource task request in the depicted embodiment may lead to, or convert to an executed order 337 for the specific resource. The executed order 337 is then recorded in the order book 350, which is part of the market 340, which is the environment of the reinforcement learning framework. Self-awareness input data 360 include feature data generated as a consequence of the action αₜ 335 (e.g., the most recently executed order 337) by the agent 180 and possibly include historical feature data generated as a consequence of previous actions (e.g., previous orders executed based on previous resource task requests) by the agent 180. The feature data may relate to a single feature, i.e., data for a specific feature relevant to a given resource. When the resource is a security, the feature may be, as a non-limiting example, the volatility, a mid-point price, or a market spread of the security.

The feature data may be extracted from the order book 350, for example by a feature extraction unit 112 (not shown in FIG. 3), and processed as self-awareness input data 360. Feature data may be represented by the variable xₙ, and include for example, volatility, a mid-point price, or a market spread of a given resource (e.g., a security) at time n, where n = 1, 2 ... N. In the depicted embodiment, the variable xₜ represents a current feature data at the present time, or the most recent timestamp t, and generated as a consequence of the action αₜ 335 (e.g., the most recently executed order 337) on a given resource Y by the agent 180. In some embodiments, xᵢ, i = 1, 2 ... N represent historical feature data or historical feature data structures 362 of the given resource Y in the order book 350 stored in the platform 100, and may have been previously computed based on previous actions of the agent 180 relating to the given resource Y at time i, where i = 1, 2 ... N. The previous actions may be, for example, resource task requests generated by the agent 180. The historical feature data x₁, ... x_{N-1}, x_{N} 362 may each be associated with a timestamp, and the plurality of timestamps for the historical feature data 362 may be consecutive or inconsecutive.

The self-awareness input data 360 are then normalized within the scope of one parent order based on a process described next. Normalization block 370 shows an example normalization process to normalize a current feature data xₜ generated based on action αₜ 335 at present time t in real time or near real time. A plurality of historical feature data xᵢ, i = 1, 2 ... N (also expressed as x₁, ... x_{N-1}, x_{N}) 362 may be used to compute an average historical feature data or average historical feature data structure µₜ 364. For example,

$${\text{μ}}_{t} = \frac{{\sum }_{i = 1}^{\text{N}} {x}_{i}}{\text{N}} .$$

.

Next, a standard deviation or a standard deviation data structure σₜ 366 may be generated based on the plurality of historical feature data x₁, ... x_{N-1},x_{N} 362 and the average historical feature data µₜ 364, for example,

$${σ}_{t} = \sqrt{\frac{\sum {}_{i = 1}^{\text{N}} {\left({x}_{i} {μ}_{t}\right)}^{2}}{\text{N}}} .$$

A normalized variable Zₜ 368 at present time t may be generated from the average historical feature data µₜ 364 and the standard deviation 366, for example,

$${Z}_{t} = \frac{{x}_{t} - {μ}_{t}}{{σ}_{t}} .$$

The normalized variable Zₜ 368 may also be referred to as normalized feature data Zₜ 368.

The normalized feature data Zₜ 368 may be added or appended to the current state data Sₜ 320 at present time t, to generate an updated or supplemented state data Sₜ 320. The supplemented state data Sₜ 320 is then relayed to the agent 180 as an input for training. For example, the normalized feature data Zₜ 368 may be an element (or multiple elements) within a state vector representing the supplemented state data Sₜ 320. In some embodiments, the plurality of historical feature data x₁, ... x_{N-1}, x_{N} 362 are chosen from a time period that immediately precede the present time t. For example, the plurality of historical feature data x₁, ... x_{N-1}, x_{N} 362 can be chosen from a plurality of prior time steps or timestamps that covers an hour, three hours, or a day immediately preceding the present time t. The duration (e.g., an hour, three hours, or a day) of the time period may be predefined, or dynamic. Having a time period substantially less than one day provides opportunity for the automated agent 180 to learn how the market changes in response to the task requests over the course of a day. In some embodiments, the duration of the time period may be adjusted in dependence on the volume of trade activity for a given trade venue. In some embodiments, duration of the time period may be adjusted in dependence on the volume of trade activity for a given resource.

The self-awareness input data 360 and the normalized feature data Zₜ 368 enable the agent 180 to learn based on input that are drive by the agent’s own actions in the time period immediately preceding the present time, as opposed to based on data and actions by everyone in the environment (e.g., by other agents or by human traders). The normalized feature data Zₜ 368 in the supplemented state data Sₜ 320 provides insight into how the environment (e.g., the market 340) responds and changes as a result of the agent’s own action, relative to the agent’s past behaviours in the environment, and in particular with respect to a single feature of a given resource.

In the disclosed configuration, the agent 180 learns to adjust its policy 330 based on how the market responds to its past actions. The agent 180 can therefore improve its policy and response by anchoring it within a local range that is determined based on the agent’s own past behaviour, which can be represented by the normalized feature data Zₜ 368 computed based on a set of historical feature data 362 as part of the self-awareness input 360. For instance, if the feature data used for computing the normalized feature data Zₜ 368 is volatility, the volatility of the resource can be then controlled within a local range, in terms of magnitude and/or direction, as determined by the agent’s historical feature data.

In some embodiments, the feature data xₜ may include multiple types of feature data, such as a combination of two or more of: a volatility, a price, a volume, a market spread, and so on.

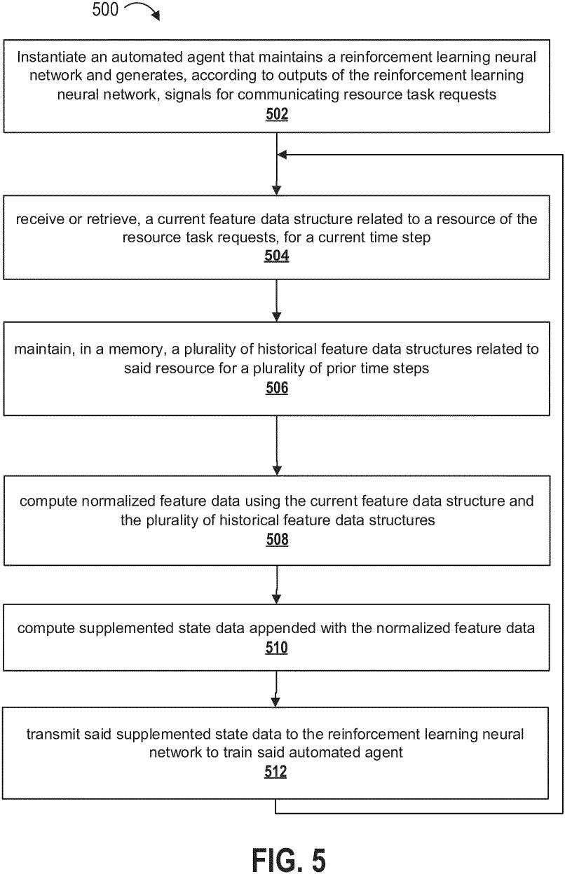

The operation of system 100 is further described with reference to the flowchart illustrated in FIG. 5, exemplary of embodiments. As depicted in FIG. 5, trading platform 100 performs operations 500 and onward to train an automated agent 180.

At operation 502, platform 100 instantiates an automated agent 180 that maintains a reinforcement learning neural network 110, e.g., using data descriptive of the neural network stored in data storage 120. The automated agent 180 generates, according to outputs of its reinforcement learning neural network, signals for communicating resource task requests for a given resource (e.g., a given security). For example, the automated agent 180 may receive a trade order for a given security as input data and then generate signals for a plurality of resource task requests corresponding to trades for child trade order slices of that security. Such signals may be communicated to a trading venue by way of communication interface 106.

At operation 504, platform 100 receives, by way of communication interface 106, a current feature data structure xₜ related to a resource of the resource task request(s) for a current time step t. For example, the current feature data structure xₜ may be related to a resource specified in a task completed in response to a most recent resource task request communicated by the automated agent 180. In some embodiments, as an alternative to being sent to the platform 100 via the communication interface 106, the current feature data structure xₜ may be generated by the feature extraction unit 112 based on available task data of the completed task related to the resource task request, stored on a local memory, and retrieved from the local memory by the platform 100.

A completed task can include completed trades in a given resource (e.g., a given security) based on action αₜ 335, and the values included in the current feature data structure xₜ can include, for example, values for prices, volumes, volatility, or market spread for the completed trade(s) in the order 337.

At operation 506, platform 100 maintains, in a local memory, a plurality of historical feature data structures 362 related to the resource for a plurality of prior time steps. For example, each of the plurality of historical feature data structures 362 can be computed based on a respective previous task completed at a respective prior time step, in response to a respective previous resource task request communicated by said automated agent 180. For example, historical feature data structure 362 of the given resource may be xᵢ, i = 1, 2 ... N may be stored in an order book 350, and may have been previously computed based on previous actions of the agent 180 relating to the given resource at time i, where i = 1, 2 ... N. The previous actions may be, for example, resource task requests generated by the agent 180.

At operation 508, platform 100 computes a normalized feature data Zₜ 368 based on the current feature data structure xₜ and the plurality of historical feature data structures xᵢ, i = 1, 2 ... N 362. For example, the normalized feature data Zₜ 368 can be computed based on the xₜ and xᵢ, i = 1, 2 ... N. In some embodiments, a plurality of historical feature data structures xᵢ, i = 1, 2 ... N (also expressed as x₁, ... x_{N-1}, x_{N}) 362 may be used to compute an average historical feature data structure µₜ 364. For example,

$${μ}_{t} = \frac{\sum {}_{i = 1}^{\text{N}} {x}_{i}}{\text{N}} .$$

Next, still within operation 508, a standard deviation or a standard deviation data structure σₜ 366 may be generated based on the plurality of historical feature data structures x₁, ... x_{N-1}, x_{N} 362 and the average historical feature data structure µₜ 364, for example, σₜ =

$$\sqrt{\frac{\sum {}_{i - 1}^{\text{N}} {\left({x}_{i} - {μ}_{t}\right)}^{2}}{\text{N}}} .$$

A normalized feature data Zₜ 368 at present time t may be generated from the average historical feature data structure µₜ 364 and the standard deviation data structure 366, for example,

$${\text{Z}}_{t} = \frac{{x}_{t} - {μ}_{t}}{{σ}_{t}} \text{} \text{} .$$

At operation 510, platform 100 computes compute a supplemented state data Sₜ 320 at present time t including the normalized feature data Zₜ 368. For example, the normalized feature data Zₜ 368 may be one or more element(s) appended to a state vector previously in the state data Sₜ 320.

At operation 512, platform 100 transmits the supplemented state data Sₜ 320 at present time t to reinforcement learning neural network 110 of the automated agent 180 to train the automated agent 180. The supplemented state data Sₜ 320 may be a data structure used to train the automated agent 180 along with the reward 310.

The training process may continue by repeating operations 504 through 512 for successive time intervals, e.g., until trade orders received as input data are completed. Conveniently, repeated performance of these operations or blocks causes automated agent 180 to become further optimized at making resources task requests, e.g., in some embodiments by improving the price of securities traded, improving the volume of securities traded, improving the timing of securities traded, and/or improving adherence to a desired trading schedule. As will be appreciated, the optimization results will vary from embodiment to embodiment.

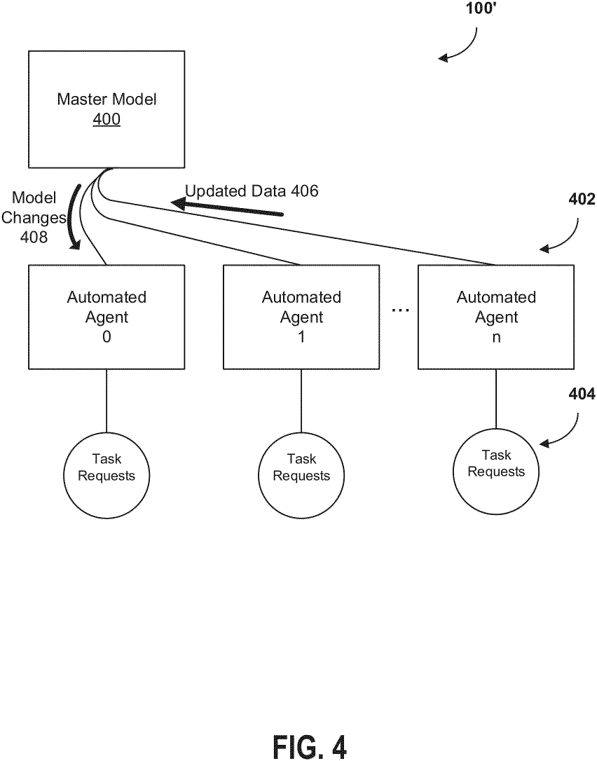

FIG. 4 depicts an embodiment of platform 100' having a plurality of automated agents 402. Each of the plurality of automated agents 402 may be an automated agent 180 in the platform 100. In this embodiment, data storage 120 stores a master model 400 that includes data defining a reinforcement learning neural network for instantiating one or more automated agents 402.

During operation, platform 100' instantiates a plurality of automated agents 402 according to master model 400 and performs operations depicted in FIG. 5 for each automated agent 402. For example, each automated agent 402 generates tasks requests 404 according to outputs of its reinforcement learning neural network 110.

As the automated agents 402 learn during operation, platform 100' obtains updated data 406 from one or more of the automated agents 402 reflective of learnings at the automated agents 402. Updated data 406 includes data descriptive of an “experience” of an automated agent in generating a task request. Updated data 406 may include one or more of: (i) input data to the given automated agent 402 and applied normalizations (ii) a list of possible resource task requests evaluated by the given automated agent with associated probabilities of making each requests, and (iii) one or more rewards for generating a task request.

Platform 100' processes updated data 406 to update master model 400 according to the experience of the automated agent 402 providing the updated data 406. Consequently, automated agents 402 instantiated thereafter will have benefit of the learnings reflected in updated data 406. Platform 100' may also sends model changes 408 to the other automated agents 402 so that these pre-existing automated agents 402 will also have benefit of the learnings reflected in updated data 406. In some embodiments, platform 100' sends model changes 408 to automated agents 402 in quasi-real time, e.g., within a few seconds, or within one second. In one specific embodiment, platform 100' sends model changes 408 to automated agents 402 using a stream-processing platform such as Apache Kafka, provided by the Apache Software Foundation. In some embodiments, platform 100' processes updated data 406 to optimize expected aggregate reward across based on the experiences of a plurality of automated agents 402.

In some embodiments, platform 100' obtains updated data 406 after each time step. In other embodiments, platform 100' obtains updated data 406 after a predefined number of time steps, e.g., 2, 5, 10, etc. In some embodiments, platform 100' updates master model 400 upon each receipt updated data 406. In other embodiments, platform 100' updates master model 400 upon reaching a predefined number of receipts of updated data 406, which may all be from one automated agent 402 or from a plurality of automated agents 402.

In one example, platform 100' instantiates a first automated agent 402 and a second automated agent 402, each from master model 400. Platform 100' obtains updated data 406 from the first automated agents 402. Platform 100' modifies master model 400 in response to the updated data 406 and then applies a corresponding modification to the second automated agent 402. Of course, the roles of the automated agents 402 could be reversed in another example such that platform 100' obtains updated data 406 from the second automated agent 402 and applies a corresponding modification to the first automated agent 402.

In some embodiments of platform 100', an automated agent may be assigned all tasks for a parent order. In other embodiments, two or more automated agent 400 may cooperatively perform tasks for a parent order; for example, child slices may be distributed across the two or more automated agents 402.

In the depicted embodiment, platform 100' may include a plurality of I/O units 102, processors 104, communication interfaces 106, and memories 108 distributed across a plurality of computing devices. In some embodiments, each automated agent may be instantiated and/or operated using a subset of the computing devices. In some embodiments, each automated agent may be instantiated and/or operated using a subset of available processors or other compute resources. Conveniently, this allows tasks to be distributed across available compute resources for parallel execution. Other technical advantages include sharing of certain resources, e.g., data storage of the master model, and efficiencies achieved through load balancing. In some embodiments, number of automated agents 402 may be adjusted dynamically by platform 100'. Such adjustment may depend, for example, on the number of parent orders to be processed. For example, platform 100' may instantiate a plurality of automated agents 402 in response to receive a large parent order, or a large number of parent orders. In some embodiments, the plurality of automated agents 402 may be distributed geographically, e.g., with certain of the automated agent 402 placed for geographic proximity to certain trading venues.

In some embodiments, the operation of platform 100' adheres to a master-worker pattern for parallel processing. In such embodiments, each automated agent 402 may function as a “worker” while platform 100' maintains the “master” by way of master model 400.

Platform 100' is otherwise substantially similar to platform 100 described herein and each automated agent 402 is otherwise substantially similar to automated agent 180 described herein.

Pricing Features: In some embodiments, input normalization may involve the training engine 118 computing pricing features. In some embodiments, pricing features for input normalization may involve price comparison features, passive price features, gap features, and aggressive price features.

Price Comparing Features: In some embodiments, price comparison features can capture the difference between the last (most current) Bid/Ask price and the Bid/Ask price recorded at different time intervals, such as 30 minutes and 60 minutes ago: qt_Bid30, qt_Ask30, qt_Bid60, qt_Ask60. A bid price comparison feature can be normalized by the difference of a quote for a last bid/ask and a quote for a bid/ask at a previous time interval which can be divided by the market average spread. The training engine 118 can “clip” the computed values between a defined ranged or clipping bound, such as between -1 and 1, for example. There can be 30 minute differences computed using clipping bound of -5, 5 and division by 10, for example.

An Ask price comparison feature (or difference) can be computed using an Ask price instead of Bid price. For example, there can be 60-minute differences computed using clipping bound of -10, 10 and division by 10.

Passive Price: The passive price feature can be normalized by dividing a passive price by the market average spread with a clipping bound. The clipping bound can be 0, 1, for example.

Gap: The gap feature can be normalized by dividing a gap price by the market average spread with a clipping bound. The clipping bound can be 0, 1, for example.

Aggressive Price: The aggressive price feature can be normalized by dividing an aggressive price by the market average spread with a clipping bound. The clipping bound can be 0, 1, for example.

Volume and Time Features: In some embodiments, input normalization may involve the training engine 118 computing volume features and time features. In some embodiments, volume features for input normalization involves a total volume of an order, a ratio of volume remaining for order execution, and schedule satisfaction. In some embodiments, the time features for input normalization involves current time of market, a ratio of time remaining for order execution, and a ratio of order duration and trading period length.

Ratio of Order Duration and Trading Period Length: The training engine 118 can compute time features relating to order duration and trading length. The ratio of total order duration and trading period length can be calculated by dividing a total order duration by an approximate trading day or other time period in seconds, minutes, hours, and so on. There may be a clipping bound.

Current Time of the Market: The training engine 118 can compute time features relating to current time of the market. The current time of the market can be normalized by the different between the current market time and the opening time of the day (which can be a default time), which can be divided by an approximate trading day or other time period in seconds, minutes, hours, and so on.

Total Volume of the Order: The training engine 118 can compute volume features relating to the total order volume. The training engine 118 can train the reinforcement learning network 110 using the normalized order count. The total volume of the order can be normalized by dividing the total volume by a scaling factor (which can be a default value).

Ratio of time remaining for order execution: The training engine 118 can compute time features relating to the time remaining for order execution. The ratio of time remaining for order execution can be calculated by dividing the remaining order duration by the total order duration. There may be a clipping bound.

Ratio of volume remaining for order execution: The training engine 118 can compute volume features relating to the remaining order volume. The ratio of volume remaining for order execution can be calculated by dividing the remaining volume by the total volume. There may be a clipping bound.

Schedule Satisfaction: The training engine 118 can compute volume and time features relating to schedule satisfaction features. This can give the model a sense of how much time it has left compared to how much volume it has left. This is an estimate of how much time is left for order execution. A schedule satisfaction feature can be computed the a different of the remaining volume divided by the total volume and the remaining order duration divided by the total order duration. There may be a clipping bound.

VWAPs Features: In some embodiments, input normalization may involve the training engine 118 computing Volume Weighted Average Price features. In some embodiments, Volume Weighted Average Price features for input normalization may involve computing current Volume Weighted Average Price features and quoted Volume Weighted Average Price features.

Current VWAP: Current VWAP can be normalized by the current VWAP adjusted using a clipping bound, such as between -4 and 4 or 0 and 1, for example.

Quote VWAP: Quote VWAP can be normalized by the quoted VWAP adjusted using a clipping bound, such as between -3 and 3 or -1 and 1, for example.

Market Spread Features In some embodiments, input normalization may involve the training engine 118 computing market spread features. In some embodiments, market spread features for input normalization may involve spread averages computed over different time frames.

Several spread averages can be computed over different time frames according to the following equations.

Spread average: Spread average can be the difference between the bid and the ask on the exchange (e.g., on average how large is that gap). This can be the general time range for the duration of the order. The spread average can be normalized by dividing the spread average by the last trade price adjusted using a clipping bound, such as between 0 and 5 or 0 and 1, for example.

Spread σ: Spread σ can be the bid and ask value at a specific time step. The spread can be normalized by dividing the spread by the last trade price adjusted using a clipping bound, such as between 0 and 2 or 0 and 1, for example.

Bounds and Bounds Satisfaction In some embodiments, input normalization may involve computing upper bounds, lower bounds, and a bounds satisfaction ratio. The training engine 118 can train the reinforcement learning network 110 using the upper bounds, the lower bounds, and the bounds satisfaction ratio.

Upper Bound: Upper bound can be normalized by multiplying an upper bound value by a scaling factor (such as 10, for example).

Lower Bound: Lower bound can be normalized by multiplying a lower bound value by a scaling factor (such as 10, for example).

Bounds Satisfaction Ratio: Bounds satisfaction ratio can be calculated by a difference between the remaining volume divided by a total volume and remaining order duration divided by a total order duration, and the lower bound can be subtracted from this difference. The result can be divided by the difference between the upper bound and the lower bound. As another example, bounds satisfaction ratio can be calculated by the difference between the schedule satisfaction and the lower bound divided by the difference between the upper bound and the lower bound.

Queue Time: In some embodiments, platform 100 measures the time elapsed between when a resource task (e.g., a trade order) is requested and when the task is completed (e.g., order filled), and such time elapsed may be referred to as a queue time. In some embodiments, platform 100 computes a reward for reinforcement learning neural network 110 that is positively correlated to the time elapsed, so that a greater reward is provided for a greater queue time. Conveniently, in such embodiments, automated agents may be trained to request tasks earlier which may result in higher priority of task completion.

Orders in the Order Book: In some embodiments, input normalization may involve the training engine 118 computing a normalized order count or volume of the order. The count of orders in the order book can be normalized by dividing the number of orders in the order book by the maximum number of orders in the order book (which may be a default value). There may be a clipping bound.

In some embodiments, the platform 100 can configured interface application 130 with different hot keys for triggering control commands which can trigger different operations by platform 100.

One Hot Key for Buy and Sell: In some embodiments, the platform 100 can configured interface application 130 with different hot keys for triggering control commands. An array representing one hot key encoding for Buy and Sell signals can be provided as follows:
Buy: [1, 0]
Sell: [0, 1]

One Hot Key for action: An array representing one hot hey encoding for task actions taken can be provided as follows:
Pass: [1, 0, 0, 0, 0, 0]
Aggressive: [0, 1, 0, 0, 0, 0,]
Top: [0, 0, 1, 0, 0, 0]
Append: [0, 0, 0, 1, 0, 0]
Prepend: [0, 0, 0, 0, 1, 0]
Pop: [0, 0, 0, 0, 0, 1]

In some embodiments, other task actions that can be requested by an automated agent include:
Far touch - go to ask
Near touch - place at bid
Layer in - if there is an order at near touch, order about near touch
Layer out - if there is an order at far touch, order close far touch
Skip - do nothing
Cancel - cancel most aggressive order

In some embodiments, the fill rate for each type of action is measured and data reflective of fill rate is included in task data received at platform 100.

In some embodiments, input normalization may involve the training engine 118 computing a normalized market quote and a normalized market trade. The training engine 118 can train the reinforcement learning network 110 using the normalized market quote and the normalized market trade.

Market Quote: Market quote can be normalized by the market quote adjusted using a clipping bound, such as between -2 and 2 or 0 and 1, for example.

Market Trade: Market trade can be normalized by the market trade adjusted using a clipping bound, such as between -4 and 4 or 0 and 1, for example.

Spam Control: The input data for automated agents 180 may include parameters for a cancel rate and/or an active rate.

Scheduler: In some embodiment, the platform 100 can include a scheduler 116. The scheduler 116 can be configured to follow a historical Volume Weighted Average Price curve to control the reinforcement learning network 110 within schedule satisfaction bounds computed using order volume and order duration. The scheduler 116 can compute schedule satisfaction data to provide the model or reinforcement learning network 110 a sense of how much time it has in comparison to how much volume remains. The schedule satisfaction data is an estimate of how much time is left for the reinforcement learning network 110 to complete the requested order or trade. For example, the scheduler 116 can compute the schedule satisfaction bounds by looking at a different between the remaining volume over the total volume and the remaining order duration over the total order duration.

In some embodiments, automated agents may train on data reflective of trading volume throughout a day, and the generation of resource requests by such automated agents need not be tied to historical volumes. For example, conventionally, some agent upon reaching historical bounds (e.g., indicative of the agent falling behind schedule) may increase aggression to stay within the bounds, or conversely may also increase passivity to stay within bounds, which may result in less optimal trades.

The scheduler 116 can be configured to follow a historical VWAP curve. The difference is that he bounds of the scheduler 116 are fairly high, and the reinforcement learning network 110 takes complete control within the bounds.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

1. A computer-implemented system for training an automated agent, the system comprising:
a communication interface;
at least one processor;
memory in communication with said at least one processor;
software code stored in said memory, which when executed at said at least one processor causes said system to:
instantiate an automated agent that maintains a reinforcement learning neural network and generates, according to outputs of said reinforcement learning neural network, signals for communicating resource task requests;
receive, by way of said communication interface, a current feature data structure related to a resource of the resource task requests, for a current time step;
maintain, in said memory, a plurality of historical feature data structures related to said resource for a plurality of prior time steps;
compute normalized feature data using the current feature data structure and the plurality of historical feature data structures;
compute supplemented state data appended with the normalized feature data; and
transmit said supplemented state data to the reinforcement learning neural network to train said automated agent.

2. The system of claim 1, wherein computing the normalized feature data based on the current feature data structure and the plurality of historical feature data structures comprises:
computing an average historical feature data structure based on the plurality of historical feature data structures;
computing a standard deviation data structure based on the plurality of historical feature data structures; and
computing the normalized feature data based on the current feature data structure, the average historical feature data structure and the standard deviation data structure.

3. The system of claim 2, wherein the standard deviation data structure is computed based on the average historical feature data structure.

4. The system of claim 3, wherein the average historical feature data structure µₜ is computed based on:
$${\text{μ}}_{\text{t}} = \frac{\sum {}_{i = 1}^{\text{N}} {x}_{i}}{\text{N}} ,$$
wherein xᵢ, i = 1, 2 ...N represents the plurality of historical feature data structures.

5. The system of claim 4, wherein the standard deviation data structure σₜ is computed based on:
$${\text{σ}}_{t} = \sqrt{\frac{{\text{Σ}}_{i = 1}^{\text{Ν}} {\left({x}_{i} - {\text{μ}}_{t}\right)}^{2}}{\text{Ν}}}$$
.

6. The system of claim 5, wherein the normalized feature data Zₜ is computed based on:
$${\text{Z}}_{t} = \frac{{x}_{t} - {μ}_{t}}{{σ}_{t}} ,$$
wherein xₜ represents the current feature data structure.

7. The system of claim 1, wherein the resource is a security, and the normalized feature data and the plurality of historical feature data structures comprise data representing a feature from: a volatility, a price, a volume, and a market spread.

8. The system of claim 1, wherein the plurality of historical feature data structures is associated with a plurality of consecutive timestamps corresponding to the plurality of prior time steps, each of the plurality of historical feature data structures being respectively associated with each of the plurality of consecutive timestamps.

9. The system of claim 8, wherein the plurality of prior time steps is taken from a period of time immediately preceding the communication of the most recent resource task request by said automated agent.

10. A computer-implemented method of training an automated agent, the method comprising:
instantiating an automated agent that maintains a reinforcement learning neural network and generates, according to outputs of said reinforcement learning neural network, signals for communicating resource task requests;
receiving or retrieving, a current feature data structure related to a resource of the resource task requests, for a current time step;
maintaining, in a memory, a plurality of historical feature data structures related to said resource for a plurality of prior time steps;
computing normalized feature data using the current feature data structure and the plurality of historical feature data structures;
computing supplemented state data appended with the normalized feature data; and
transmitting said supplemented state data to the reinforcement learning neural network to train said automated agent.

11. The method of claim 10, wherein computing the normalized feature data based on the current feature data structure and the plurality of historical feature data structures comprises:
computing an average historical feature data structure based on the plurality of historical feature data structures;
computing a standard deviation data structure based on the plurality of historical feature data structures; and
computing the normalized feature data based on the current feature data structure, the average historical feature data structure and the standard deviation data structure.

12. The method of claim 11, wherein the standard deviation data structure is computed based on the average historical feature data structure.

13. The method of claim 12, wherein the average historical feature data structure µₜ is computed based on:
$${\text{μ}}_{\text{t}} = \frac{\sum {}_{i = 1}^{\text{N}} {x}_{i}}{\text{N}} ,$$
wherein xᵢ, i = 1, 2 ... N represents the plurality of historical feature data structures.

14. The method of claim 13, wherein the standard deviation data structure σₜ is computed based on:
$${\text{σ}}_{t} \text{=} \sqrt{\frac{{\text{Σ}}_{i = 1}^{\text{N}} {\left({x}_{i} - {\text{μ}}_{t}\right)}^{\text{2}}}{\text{N}}}$$
.

15. The method of claim 14, wherein the normalized feature data Zₜ is computed based on:
$$\text{Z} {}_{t} = \frac{{x}_{t} - {μ}_{t}}{{σ}_{t}} ,$$
wherein xₜ represents the current feature data structure. σₜ.

16. The method of claim 10, wherein the resource is a security, and the normalized feature data and the plurality of historical feature data structures comprise data representing a feature from: a volatility, a price, a volume, and a market spread.

17. The method of claim 10, wherein the plurality of historical feature data structures is associated with a plurality of consecutive timestamps corresponding to the plurality of prior time steps, each of the plurality of historical feature data structures being respectively associated with each of the plurality of consecutive timestamps.

18. The method of claim 17, wherein the plurality of prior time steps is taken from a period of time immediately preceding the communication of the most recent resource task request by said automated agent.

19. A non-transitory computer-readable storage medium storing instructions which when executed adapt at least one computing device to:
instantiate an automated agent that maintains a reinforcement learning neural network and generates, according to outputs of said reinforcement learning neural network, signals for communicating resource task requests;
receive or retrieve, a current feature data structure related to a resource of the resource task requests, for a current time step;
maintain, in a memory, a plurality of historical feature data structures related to said resource for a plurality of prior time steps;
compute normalized feature data using the current feature data structure and the plurality of historical feature data structures;
compute supplemented state data appended with the normalized feature data; and
transmit said supplemented state data to the reinforcement learning neural network to train said automated agent.

20. The non-transitory computer-readable storage medium of claim 19, wherein computing the normalized feature data based on the current feature data structure and the plurality of historical feature data structures comprises:
computing an average historical feature data structure based on the plurality of historical feature data structures;
computing a standard deviation data structure based on the plurality of historical feature data structures; and
computing the normalized feature data based on the current feature data structure, the average historical feature data structure and the standard deviation data structure.
